(19) United States
(12) Patent Application Publication
(10) Pub. No.: US 2007/0296843 A1
(43) Pub. Date: Dec. 27, 2007

(54) Solid-state imaging device and camera

(76) Inventors: Shigetaka Kasuga, Osaka (JP); Katsumi Takeda, Kyoto (JP); Takumi Yamaguchi, Kyoto (JP); Yoshiyuki Matsunaga, Kanagawa (JP); Takahiko Murata, Osaka (JP); Takayoshi Yamada, Osaka (JP)

Correspondence Address: MCDERMOTT WILL & EMERY LLP, 600 13TH STREET, NW, WASHINGTON, DC, 20005-3096, US

(21) Appl. No.: 11/808,297

(22) Filed: Jun. 8, 2007

(30) Foreign Application Priority Data
Jun. 8, 2006 (JP) 2006-159606

(51) Int. Cl. H04N 5/335

(52) U.S. Cl. 348/294

(57) ABSTRACT

A solid-state imaging device includes a plurality of pixels arranged two-dimensionally. Each pixel includes a photoelectric converter (2) for converting incident light to a charge, and a gray filter (6a, 6b, 6c) having a visible light transmittance that is different depending on the photoelectric converter (2). According to this construction, the plurality of pixels have different sensitivities to incident light. By combining pixel signals obtained from three pixels having different sensitivities, a wider dynamic range can be achieved.

### BACKGROUND OF THE INVENTION

1. Field of the Invention

The present invention relates to a solid-state imaging device used in a digital camera, a mobile phone camera, a vehicle-mounted camera, and the like, and especially relates to techniques for realizing a wider dynamic range.

2. Related Art

A solid-state imaging device is considered to have a narrower dynamic range than a silver salt camera. In view of this, techniques for widening a dynamic range of a solid-state imaging device have conventionally been studied (e.g. Japanese Patent Application Publication No. 2003-218343).

FIG. 1A is a top view of pixels according to a conventional technique.

The pixels according to the conventional technique are each made up of a main photosensitive unit 301 and a sub photosensitive unit 302. The sub photosensitive unit 302 has a smaller photoreceptive area than the main photosensitive unit 301. A charge obtained in each photosensitive unit is separately output via a charge transfer path 303.

FIG. 1B shows output characteristics of a solid-state imaging device according to the conventional technique.

Curves 71 and 72 respectively indicate output characteristics of the main photosensitive unit 301 and the sub photosensitive unit 302. In both output characteristics, an output signal increases with a light intensity but, once the light intensity has exceeded a threshold value, ceases to change even when the light intensity further increases. This is because an amount of charge accumulated in each photosensitive unit becomes saturated.

Since the main photosensitive unit 301 has a larger photoreceptive area than the sub photosensitive unit 302, the main photosensitive unit 301 receives a larger amount of light than the sub photosensitive unit 302. Accordingly, the main photosensitive unit 301 has a high sensitivity (a steep curve slope) but a narrow dynamic range (more prone to charge saturation).

On the other hand, the sub photosensitive unit 302 has a smaller photoreceptive area than the main photosensitive unit 301, and so receives a smaller amount of light than the main photosensitive unit 301. Therefore, the sub photosensitive unit 302 has a low sensitivity but a wide dynamic range.

A curve 73 indicates output characteristics when the output signal of the main photosensitive unit 301 and the output signal of the sub photosensitive unit 302 are combined by signal processing. By such combining the output signals of the two photosensitive units that differ in sensitivity, it is possible to increase the sensitivity and widen the dynamic range on the whole.

With the increasing range of uses for solid-state imaging devices in recent years, a wider dynamic range is required depending on the type of use. For example, in the case of a vehicle-mounted camera, an extremely wide dynamic range is needed to reliably capture even a backlit subject.

However, though the above conventional technique can certainly widen the dynamic range, the rate of widening of the dynamic range is still insufficient to meet such requirements.

### SUMMARY OF THE INVENTION

In view of this, the present invention aims to solve the above problem and provide a solid-state imaging device and a camera that can realize a considerably wider dynamic range.

The stated aim can be achieved by a solid-state imaging device including: a plurality of photoelectric converters each operable to generate and accumulate an amount of charge corresponding to an amount of received light; a suppression unit operable to suppress the amount of received light of each of the plurality of photoelectric converters at a rate determined for the photoelectric converter; and an obtaining unit operable to, for each group of a predetermined number of photoelectric converters, combine electric signals that are respectively based on amounts of charge accumulated in the predetermined number of photoelectric converters, thereby obtaining one composite signal for the predetermined number of photoelectric converters, wherein a maximum amount of charge that is able to be accumulated is substantially same in each of the predetermined number of photoelectric converters, and the rate of suppression by the suppression unit is different in each of the predetermined number of photoelectric converters.

According to this construction, even when the amount of received light is suppressed, the maximum amount of charge that can be accumulated is substantially same. Therefore, the dynamic range can be widened when compared with conventional techniques that cause a decrease in maximum amount of charge as a result of suppressing the amount of received light.

Here, the plurality of photoelectric converters may be each provided on a substrate, wherein the suppression unit is an optical filter film that covers the substrate and transmits visible light, and the rate of suppression by the suppression unit is different because a transmittance of visible light is different in each of areas of the optical filter film that correspond to the predetermined number of photoelectric converters.

The transmittance of the optical filter film can be easily made different by differing a material, composition ratio, film thickness, and the like of the optical filter film.

Here, the plurality of photoelectric converters may be each provided on a substrate, wherein the suppression unit is a photo-shielding film that covers the substrate and has apertures at positions corresponding to the plurality of photoelectric converters, and the rate of suppression by the suppression unit is different because a size of an aperture corresponding to each of the predetermined number of photoelectric converters is different.

The size of the aperture can be easily made different at a stage of designing an etching mask.

Here, the suppression unit may include: a discharge unit operable to discharge a charge accumulated in each of the plurality of photoelectric converters; and an accumulation unit operable to accumulate a charge in each of the plurality of photoelectric converters until a predetermined time period has elapsed since the discharge by the discharge unit, wherein the rate of suppression by the suppression unit is different because a length of the predetermined time period is different for each of the predetermined number of photoelectric converters.

The length of the predetermined time period can be easily made different at a stage of designing the accumulation unit.

Here, the solid-state imaging device may further include: a prohibition unit operable to, when an electric signal that is based on an amount of charge accumulated in any of the predetermined number of photoelectric converters indicates the maximum amount of charge, prohibit the obtaining unit from combining the electric signal.

By prohibiting the saturated electric signal from the combination in this way, a drop in resolution can be prevented.

Here, the plurality of photoelectric converters may be formed by introducing a dopant to a semiconductor substrate, wherein the maximum amount of charge is substantially same because each of the predetermined number of photoelectric converters has a substantially same capacity and a substantially same dopant concentration.

Parameters for determining the maximum amount of charge that can be accumulated are a capacity and a dopant concentration of a photoelectric converter. By using a substantially same capacity and a substantially same dopant concentration, the solid-state imaging device can be designed and manufactured most easily.

Here, the predetermined number may be at least three.

By combining three or more electric signals, smooth output characteristics can be obtained as a result of the combination, and the dynamic range can be considerably widened.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1A shows a top view of pixels according to a conventional technique;

FIG. 1B shows output characteristics of a solid-state imaging device according to the conventional technique;

FIG. 2A is a sectional view of an image sensor according to a first embodiment of the present invention;

FIG. 2B is a sectional view of the image sensor according to the first embodiment;

FIG. 3 is a top view of gray filters according to the first embodiment;

FIG. 4 shows a signal amount of each photoelectric converter according to the first embodiment;

FIG. 5 shows a construction of a solid-state imaging device according to the first embodiment;

FIG. 6 shows output characteristics of the solid-state imaging device according to the first embodiment;

FIG. 7A is a sectional view of an image sensor according to a second embodiment of the present invention;

FIG. 7B is a sectional view of the image sensor according to the second embodiment;

FIG. 8 is a top view of a photo-shielding film according to the second embodiment;

FIG. 9 is a sectional view of an image sensor according to a third embodiment of the present invention;

FIG. 10 is a top view of gray filters according to the third embodiment;

FIG. 11 shows a signal amount of each photoelectric converter according to the third embodiment;

FIG. 12 is a sectional view of an image sensor according to a fourth embodiment of the present invention;

FIG. 13 is a top view of a photo-shielding film according to the fourth embodiment;

FIG. 14 shows a construction of a solid-state imaging device according to a fifth embodiment of the present invention;

FIG. 15A shows a signal amount of each photoelectric converter according to the fifth embodiment;

FIG. 15B shows a signal amount of each photoelectric converter according to the fifth embodiment;

FIG. 16 shows a construction of a solid-state imaging device according to a seventh embodiment of the present invention;

FIG. 17 is a timing chart showing output pulses of vertical scanning circuits according to the seventh embodiment;

FIG. 18 shows a signal amount of each photoelectric converter according to the seventh embodiment;

FIG. 19 shows a signal amount of each photoelectric converter according to an eighth embodiment of the present invention;

FIG. 20A shows a signal amount of each photoelectric converter according to a tenth embodiment of the present invention;

FIG. 20B shows a signal amount of each photoelectric converter according to the tenth embodiment;

FIG. 21A is a sectional view of an image sensor according to a twelfth embodiment of the present invention;

FIG. 21B is a sectional view of the image sensor according to the twelfth embodiment;

FIG. 22 shows a construction of a solid-state imaging device according to a modification to the embodiments; and

FIG. 23 shows output characteristics of a solid-state imaging device having seven different sensitivities.

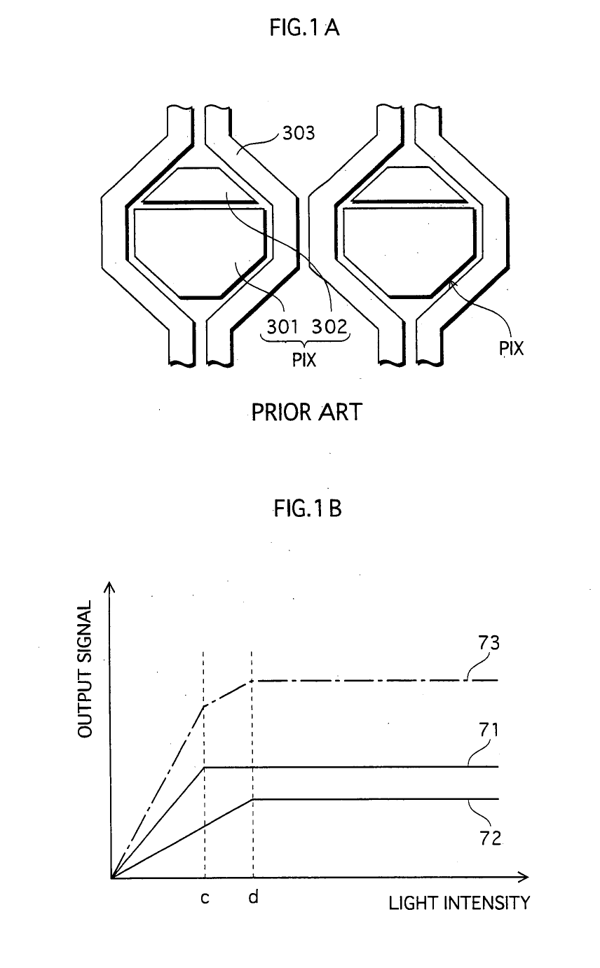

### DESCRIPTION OF THE PREFERRED EMBODIMENT(S)

The following describes embodiments of the present invention with reference to drawings.

### First Embodiment

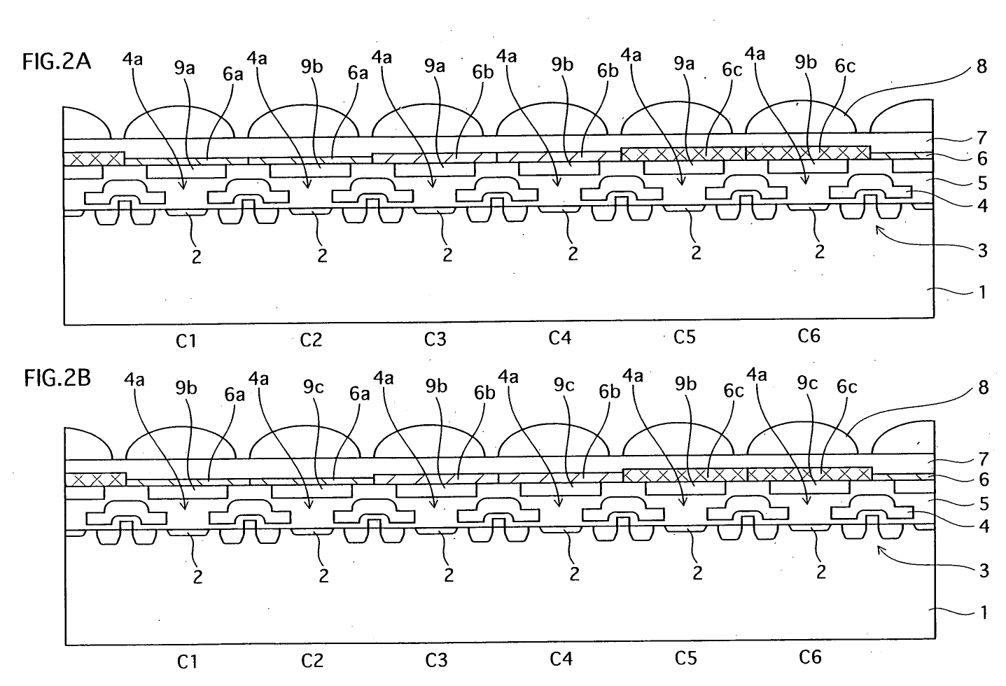

FIG. 2 is a sectional view of an image sensor according to a first embodiment of the present invention.

FIG. 2A is a sectional view of line L1, whereas FIG. 2B is a sectional view of line L2. Lines L1 and L2 are adjacent to each other.

The image sensor includes a semiconductor substrate 1, a photo-shielding film 4, an interlayer insulating film 5, gray filters 6a, 6b, and 6c, a flattening film 7, a microlens 8, and color filters 9a, 9b, and 9c.

Photoelectric converters 2 and transistors 3 are provided on the semiconductor substrate 1. The photoelectric converters 2 are formed by covering the semiconductor substrate 1 with a mask having apertures of a same size, and introducing a dopant to the semiconductor substrate 1 by ion implantation.

The photo-shielding film 4 covers the semiconductor substrate 1, and has apertures 4a at positions corresponding to the photoelectric converters 2. In the first embodiment, all of the apertures 4a have a substantially same size.

The gray filters 6a, 6b, and 6c each transmit light of all wavelength regions of visible light with a predetermined transmittance. The transmittance differs for each of the gray filters 6a, 6b, and 6c. In detail, the transmittances of the gray filters 6a, 6b, and 6c decrease in this order. A different transmittance of visible light can be easily realized by using a different material, composition ratio, film thickness, and the like for a gray filter. In this embodiment, the gray filters 6a, 6b, and 6c have different film thicknesses, thereby achieving the different visible light transmittances. A material for composing the gray filters 6a, 6b, and 6c is silicon nitride, as one example.

The color filters 9a, 9b, and 9c respectively transmit light of wavelength regions of red, green, and blue. It is assumed here that the color filters 9a, 9b, and 9c are arranged in a Bayer array.

The interlayer insulating film 5, the flattening film 7, and the microlens 8 are general construction elements of an image sensor, and so their explanation has been omitted here.

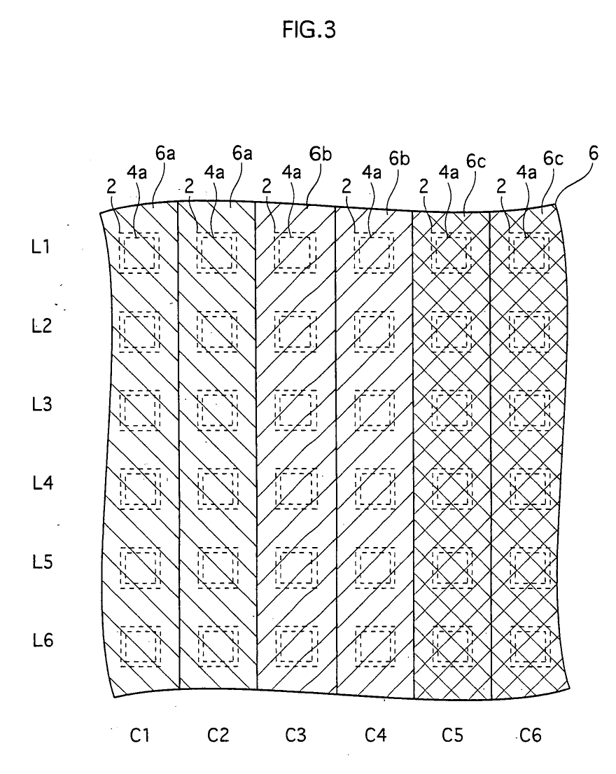

FIG. 3 is a top view of the gray filters according to the first embodiment.

Light passing through the gray filter 6a enters the photoelectric converters 2 belonging to columns C1 and C2. Light passing through the gray filter 6b enters the photoelectric converters 2 belonging to columns C3 and C4. Light passing through the gray filter 6c enters the photoelectric converters 2 belonging to columns C5 and C6.

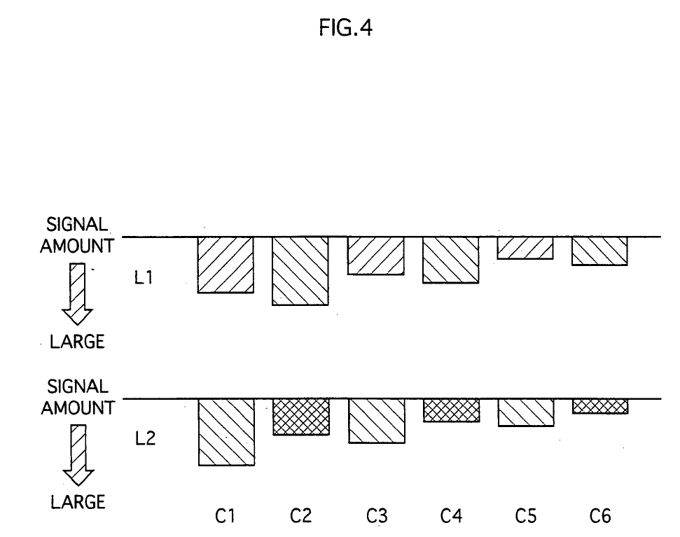

FIG. 4 shows a signal amount of each photoelectric converter according to the first embodiment.

Only lines L1 and L2 are shown in FIG. 4. In the first embodiment, the gray filters 6a, 6b, and 6c each have a different transmittance. Accordingly, even when a light intensity is equal, an amount of light passing through each of the gray filters 6a, 6b, and 6c is different. This causes a different amount of signal to be generated in a photoelectric converter 2 depending on which column the photoelectric converter 2 belongs to. Since the visible light transmittance decreases in the order of the gray filters 6a, 6b, and 6c, the signal amount decreases in this order, too. For example, the gray filters 6a, 6b, and 6c are provided respectively on columns C1, C3, and C5 of line L1, so that the signal amount decreases in the order of columns C1, C3, and C5.

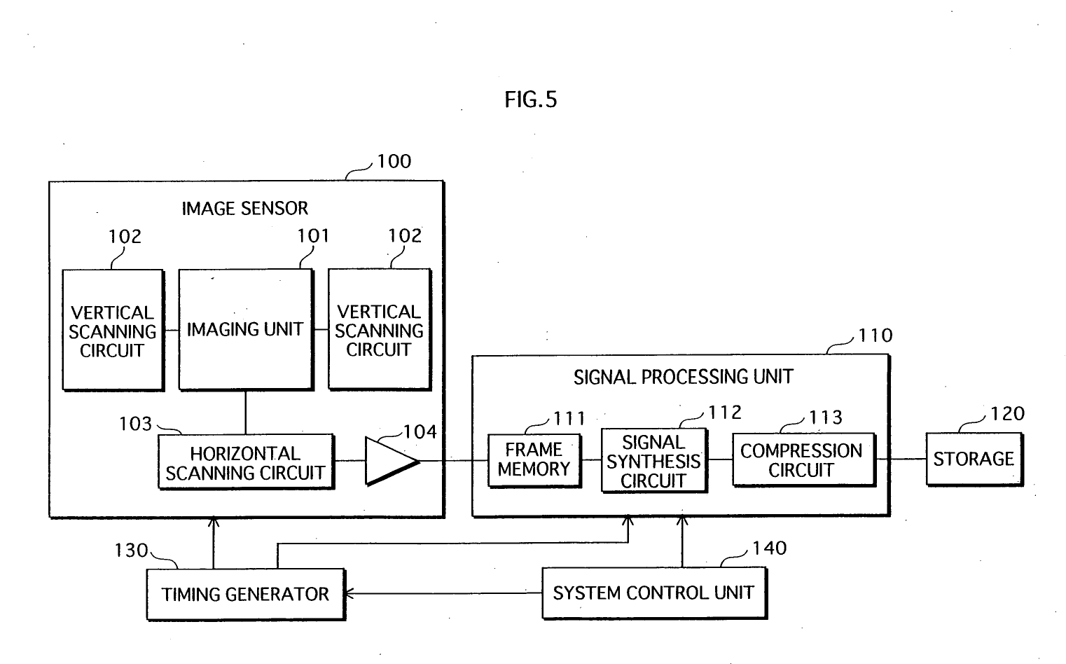

FIG. 5 shows a construction of a solid-state imaging device according to the first embodiment.

The solid-state imaging device includes an image sensor 100, a signal processing unit 110, a storage 120, a timing generator 130, and a system control unit 140.

The image sensor 100 includes an imaging unit 101, a vertical scanning circuit 102, a horizontal scanning circuit 103, and an amplifier 104. The imaging unit 101 has the photoelectric converters 2 and the like arranged two-dimensionally. The vertical scanning circuit 102 and the horizontal scanning circuit 103 each output electric signals based on an amount of charge accumulated in each photoelectric converter 2, in sequence. The electric signals are amplified by the amplifier 104.

The signal processing unit 110 includes a frame memory 111, a signal synthesis circuit 112, and a compression circuit 113.

The frame memory 111 stores each electric signal output from the image sensor 100, in units of frames.

The signal synthesis circuit 112 obtains one composite signal by combining electric signals of a predetermined number of photoelectric converters. Here, the predetermined number of photoelectric converters are three photoelectric converters of a same color adjacent on a same line.

The compression circuit 113 applies image compression such as JPEG (Joint Photographic Experts Group) or MPEG (Moving Picture Experts Group) to the composite signal.

The storage 120 stores data obtained as a result of image compression.

The timing generator 130 generates a vertical sync signal, a horizontal sync signal, and the like. The vertical sync signal is a signal for driving the vertical scanning circuit 102, while the horizontal sync signal is a signal for driving the horizontal scanning circuit 103.

The system control unit 140 generates signals such as a trigger signal for initiating photographing. The trigger signal is a signal for driving the timing generator 130.

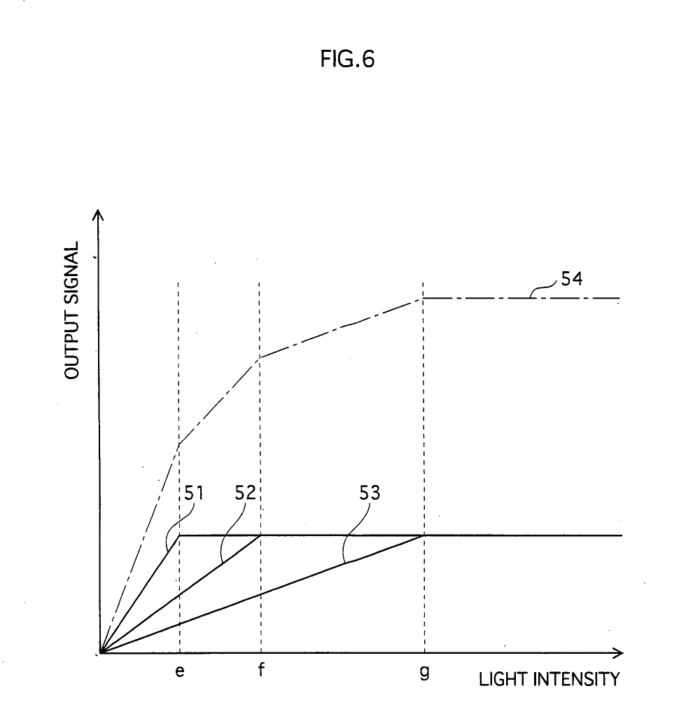

FIG. 6 shows output characteristics of the solid-state imaging device according to the first embodiment.

Curves 51, 52, and 53 indicate output characteristics of the photoelectric converters belonging to columns C1, C3, and C5. A curve 54 indicates output characteristics when output signals of these photoelectric converters are combined by signal processing.

The gray filters 6a, 6b, and 6c are disposed respectively on columns C1, C3, and C5. This makes each of the photoelectric converters belonging to columns C1, C3, and C5 differ in sensitivity. As a result, a light intensity at which an electric signal becomes saturated is different for each of the photoelectric converters belonging to columns C1, C3, and C5. By combining electric signals obtained from such three photoelectric converters having different sensitivities, the dynamic range can be considerably widened. Also, since the sensitivity of the photoelectric converters differs by three levels, smoother output characteristics of a composite signal than in conventional techniques can be achieved.

### Second Embodiment

A second embodiment of the present invention is different from the first embodiment in the construction for differing the sensitivity. The rest of the construction of the second embodiment is the same as that of the first embodiment and so its explanation has been omitted here.

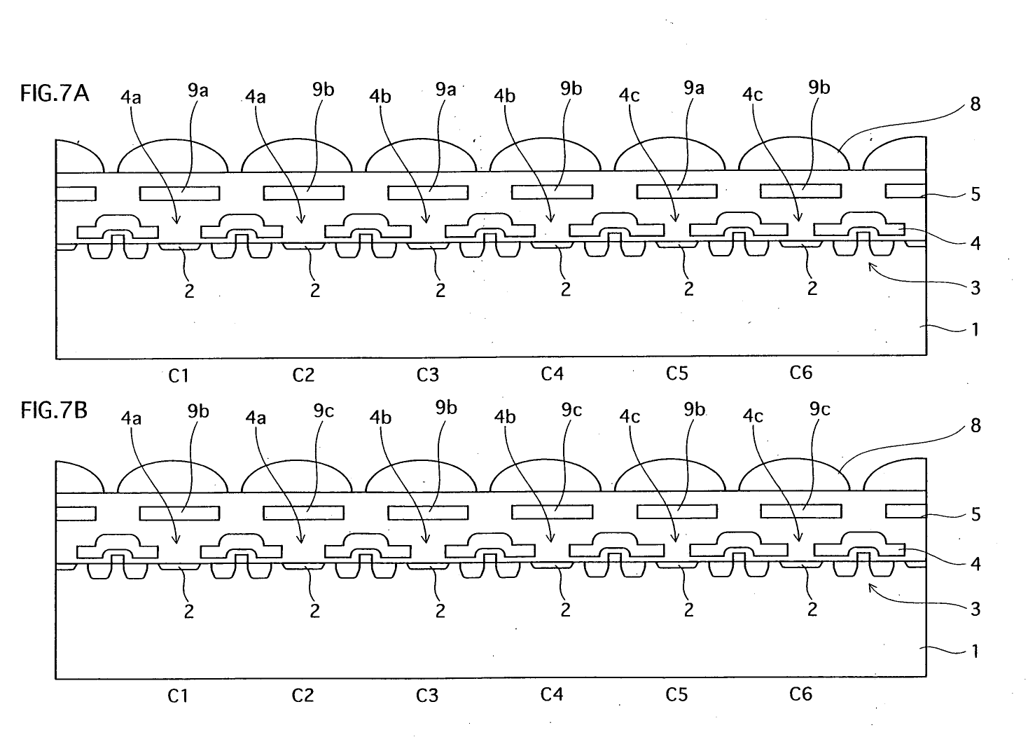

FIG. 7 is a sectional view of an image sensor according to the second embodiment.

FIG. 7A is a sectional view of line L1, whereas FIG. 7B is a sectional view of line L2.

The image sensor includes the semiconductor substrate 1, the photo-shielding film 4, the interlayer insulating film 5, the microlens 8, and the color filters 9a, 9b, and 9c.

The photoelectric converters 2 and the transistors 3 are provided on the semiconductor substrate 1. The photoelectric converters 2 are formed by covering the semiconductor substrate 1 with a mask having apertures of a same size, and introducing a dopant to the semiconductor substrate 1 by ion implantation.

The photo-shielding film 4 covers the semiconductor substrate 1, and has apertures 4a, 4b, and 4c at positions corresponding to the photoelectric converters 2. In the second embodiment, the apertures 4a, 4b, and 4c have different sizes. In detail, the apertures 4a, 4b, and 4c decrease in size in this order.

The color filters 9a, 9b, and 9c respectively transmit light of wavelength regions of red, green, and blue. It is assumed here that the color filters 9a, 9b, and 9c are arranged in a Bayer array.

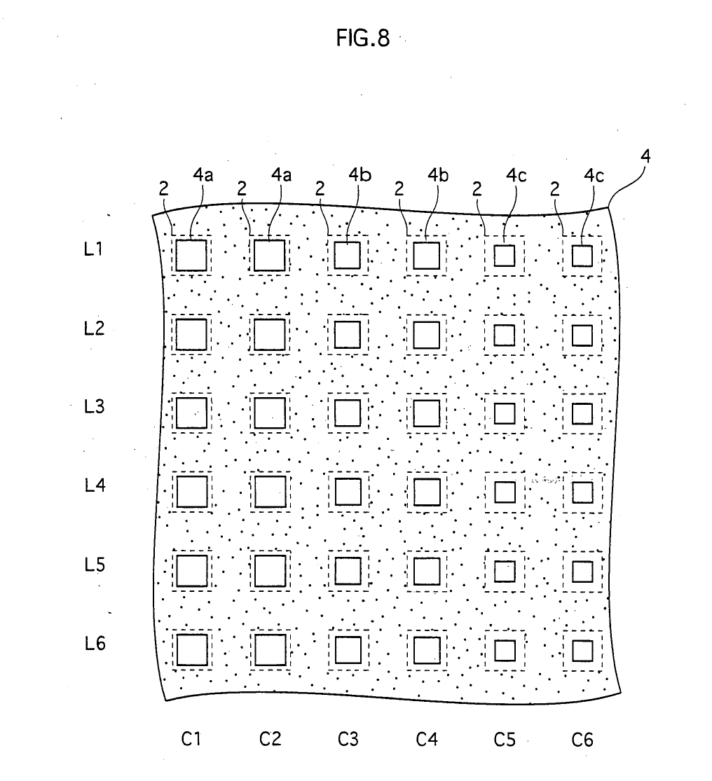

FIG. 8 is a top view of the photo-shielding film according to the second embodiment.

Light passing through the aperture 4a enters the photoelectric converters 2 belonging to columns C1 and C2. Light passing through the aperture 4b enters the photoelectric converters 2 belonging to columns C3 and C4. Light passing through the aperture 4c enters the photoelectric converters 2 belonging to columns C5 and C6.

By differing the aperture size in this way, the photoelectric converters having different sensitivities can be realized.

### Third Embodiment

A third embodiment of the present invention is different from the first embodiment in that a monochrome image sensor is used.

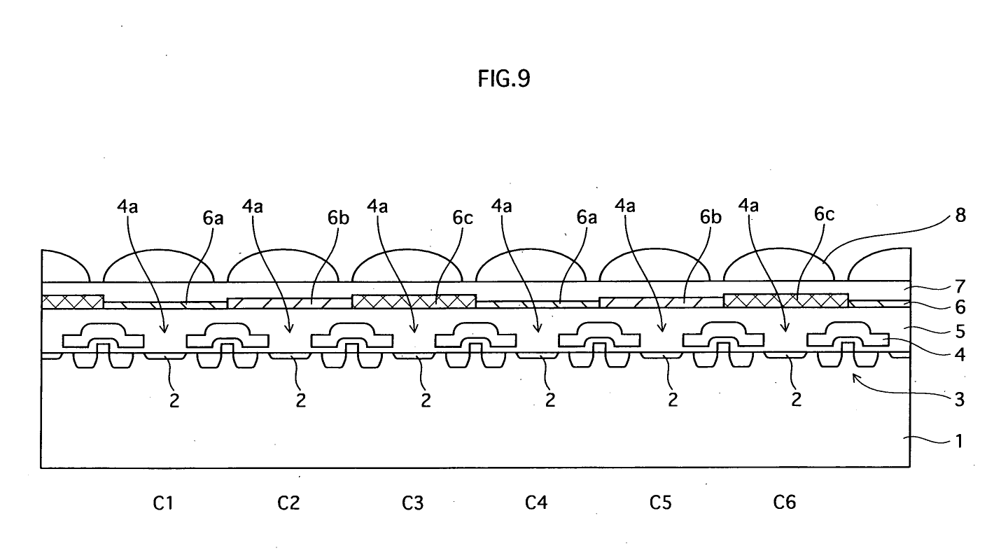

FIG. 9 is a sectional view of an image sensor according to the third embodiment.

The image sensor includes the semiconductor substrate 1, the photo-shielding film 4, the interlayer insulating film 5, the gray filters 6a, 6b, and 6c, the flattening film 7, and the microlens 8. Since the image sensor according to the third embodiment is for monochrome photographing, no color filter is provided.

The gray filters 6a, 6b, and 6c each transmit light of all wavelength regions of visible light with a predetermined transmittance. The transmittance differs for each of the gray filters 6a, 6b, and 6c. In detail, the transmittances of the gray filters 6a, 6b, and 6c decrease in this order. A different transmittance of visible light can be easily realized by using a different material, composition ratio, film thickness, and the like for a gray filter. In this embodiment, the gray filters 6a, 6b, and 6c have different film thicknesses, thereby achieving the different visible light transmittances. A material for composing the gray filters 6a, 6b, and 6c is silicon nitride, as one example.

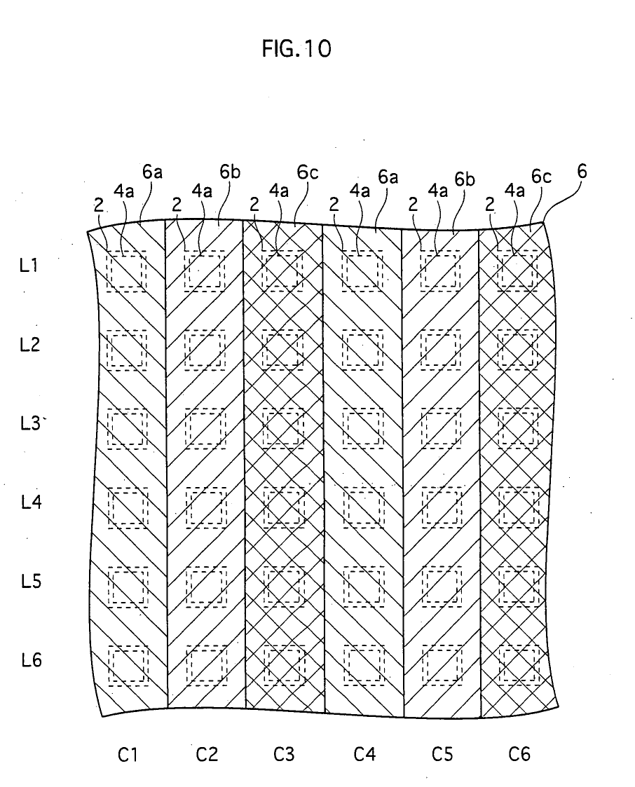

FIG. 10 is a top view of the gray filters according to the third embodiment.

Light passing through the gray filter 6a enters the photoelectric converters 2 belonging to columns C1 and C4. Light passing through the gray filter 6b enters the photoelectric converters 2 belonging to columns C2 and C5. Light passing through the gray filter 6c enters the photoelectric converters 2 belonging to columns C3 and C6.

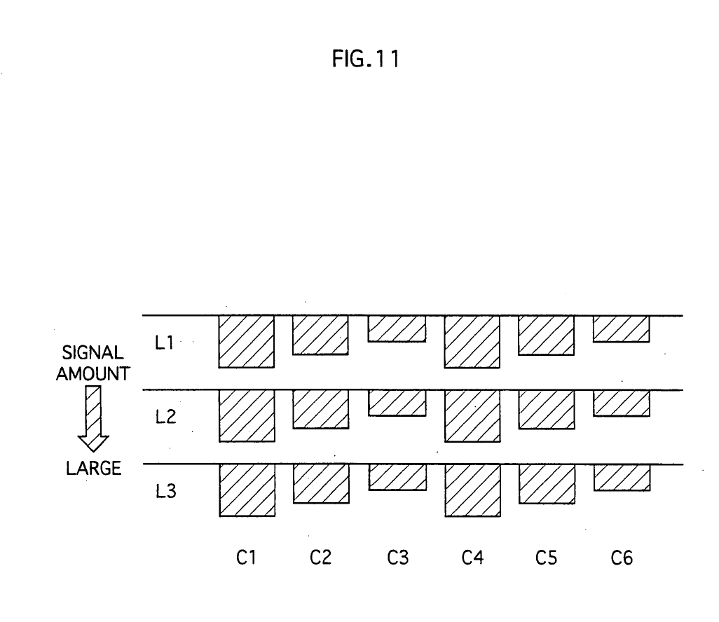

FIG. 11 shows a signal amount of each photoelectric converter according to the third embodiment.

Only lines L1, L2, and L3 are shown in FIG. 11. In the third embodiment, the gray filters 6a, 6b, and 6c each have a different transmittance. Accordingly, even when a light intensity is equal, an amount of light passing through each of the gray filters 6a, 6b, and 6c is different. This causes a different amount of signal to be generated in a photoelectric converter 2 depending on which column the photoelectric converter 2 belongs to. Since the visible light transmittance decreases in the order of the gray filters 6a, 6b, and 6c, the signal amount decreases in this order, too. For example, the gray filters 6a, 6b, and 6c are provided respectively on columns C1, C2, and C3 of line L1, the signal amount decreases in the order of columns C1, C2, and C3.

### Fourth Embodiment

A fourth embodiment of the present invention is different from the second embodiment in that a monochrome image sensor is used.

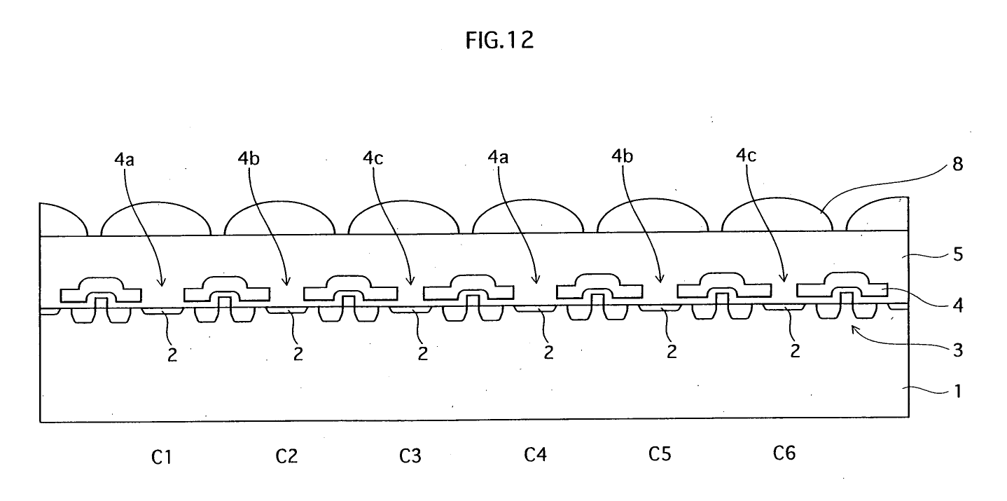

FIG. 12 is a sectional view of an image sensor according to the fourth embodiment.

The image sensor includes the semiconductor substrate 1, the photo-shielding film 4, the interlayer insulating film 5, and the microlens 8. Since the image sensor according to the fourth embodiment is for monochrome photographing, no color filter is provided.

The photo-shielding film 4 covers the semiconductor substrate 1, and has the apertures 4a, 4b, and 4c at positions corresponding to the photoelectric converters 2. In the fourth embodiment, the apertures 4a, 4b, and 4c have different sizes. In detail, the apertures 4a, 4b, and 4c decrease in size in this order.

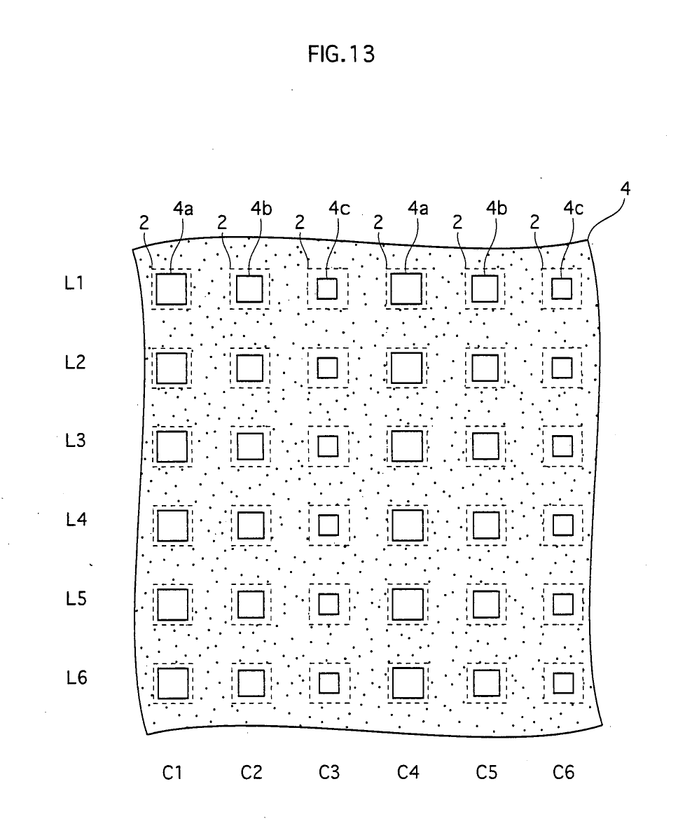

FIG. 13 is a top view of the photo-shielding film according to the fourth embodiment.

Light passing through the aperture 4a enters the photoelectric converters 2 belonging to columns C1 and C4. Light passing through the aperture 4b enters the photoelectric converters 2 belonging to columns C2 and C5. Light passing through the aperture 4c enters the photoelectric converters 2 belonging to columns C3 and C6. By differing the aperture size in this way, the photoelectric converters having different sensitivities can be realized.

### Fifth Embodiment

A fifth embodiment of the present invention is different from the first embodiment in the processing of an electric signal that has reached a saturation level. As a construction for differing the sensitivity, gray filters are used as in the first embodiment.

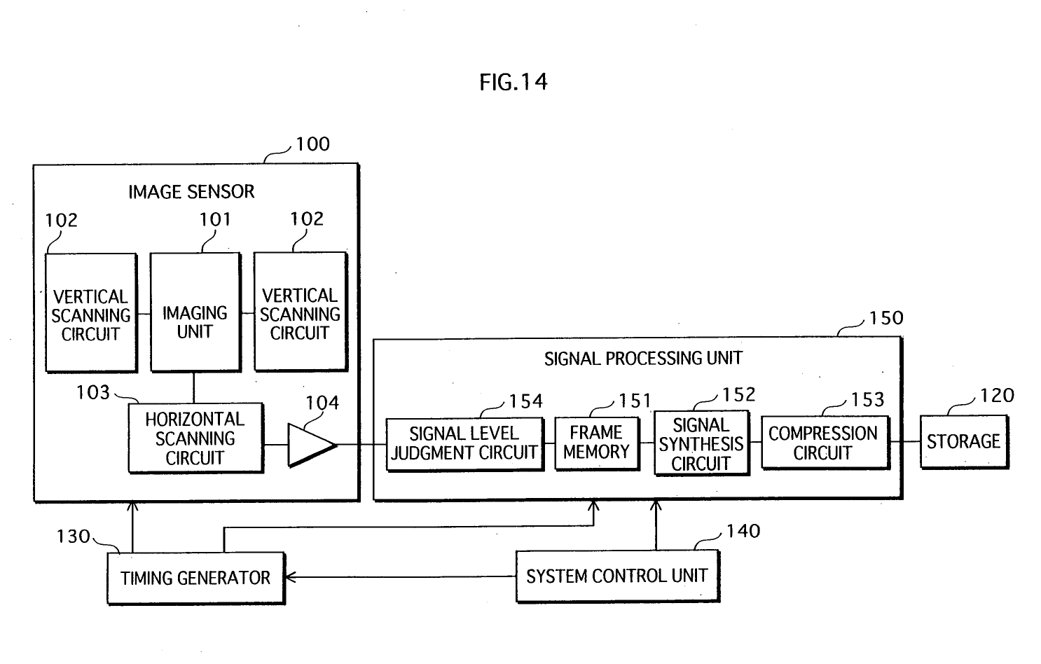

FIG. 14 shows a construction of a solid-state imaging device according to the fifth embodiment.

The solid state imaging device includes the image sensor 100, a signal processing unit 150, the storage 120, the timing generator 130, and the system control unit 140.

The signal processing unit 150 includes a frame memory 151, a signal synthesis circuit 152, a compression circuit 153, and a signal level judgment circuit 154.

The signal level judgment circuit 154 prohibits, if an electric signal output from the image sensor 100 is at a saturation level, the electric signal from being combined in the signal synthesis circuit 152.

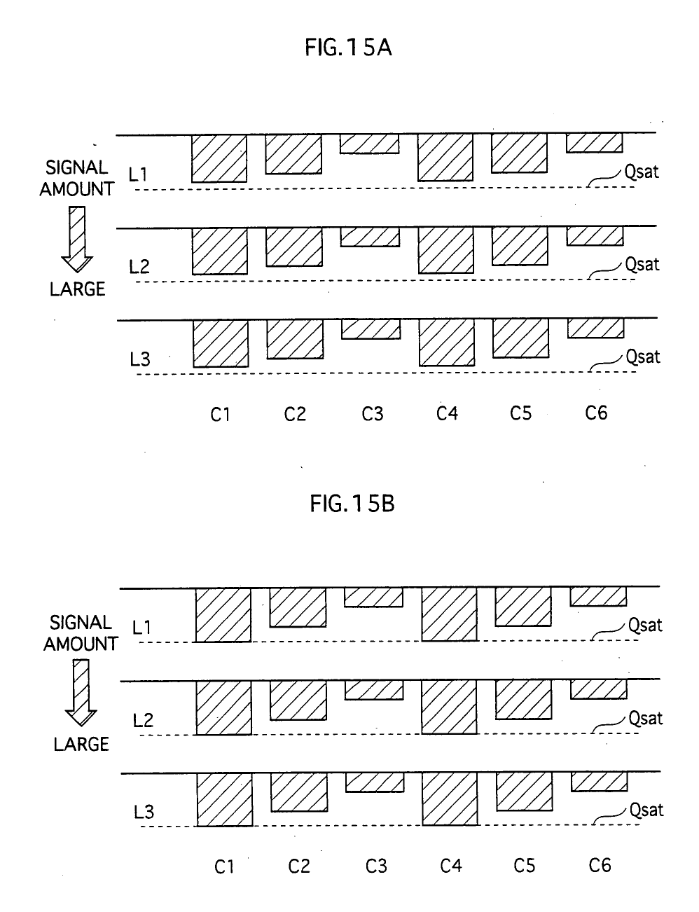

FIG. 15 shows a signal amount of each photoelectric converter according to the fifth embodiment.

Only lines L1, L2, and L3 are shown in FIG. 15. Qsat indicates the saturation level. In FIG. 15A, the electric signal obtained from each photoelectric converter is below the saturation level (low-brightness photographing mode). In this case, the electric signals obtained from the three photoelectric converters adjacent on the same line are all combined in the signal synthesis circuit 152. In FIG. 15B, on the other hand, due to a high light intensity, the electric signals obtained from the photoelectric converters on columns C1 and C4 have reached the saturation level (high-brightness photographing mode). In this case, the electric signals obtained from the photoelectric converters of columns C1 and C4 are not combined in the signal synthesis circuit 152. That is, only the unsaturated electric signals out of the electric signals obtained from the three photoelectric converters adjacent on the same line are combined in the signal synthesis circuit 152.

Thus, in the low-brightness photographing mode, the three pixel signals are combined together, with it being possible to considerably widen the dynamic range. In the high-brightness photographing mode, meanwhile, only the unsaturated pixel signals out of the three pixel signals are combined together, with it being possible to suppress a drop in resolution.

### Sixth Embodiment

A sixth embodiment of the present invention applies the electric signal processing of the fifth embodiment to the second embodiment. As a construction for differing the sensitivity, apertures of a photo-shielding film are used as in the second embodiment. In detail, when the electric signals obtained from the three photoelectric converters adjacent on the same line are below the saturation level, the electric signals are all combined in the signal synthesis circuit 152. When any of the electric signals obtained from the three photoelectric converters adjacent on the same line has reached the saturation level, on the other hand, only the unsaturated electric signals are combined in the signal synthesis circuit 152.

Thus, in the low-brightness photographing mode, the three pixel signals are combined together, with it being possible to considerably widen the dynamic range. In the high-brightness photographing mode, meanwhile, only the unsaturated pixel signals out of the three pixel signals are combined together, with it being possible to suppress a drop in resolution.

### Seventh Embodiment

A seventh embodiment of the present invention is different from the first embodiment in the construction for differing the sensitivity. The rest of the construction of the seventh embodiment is the same as that of the first embodiment, so that its explanation has been omitted here.

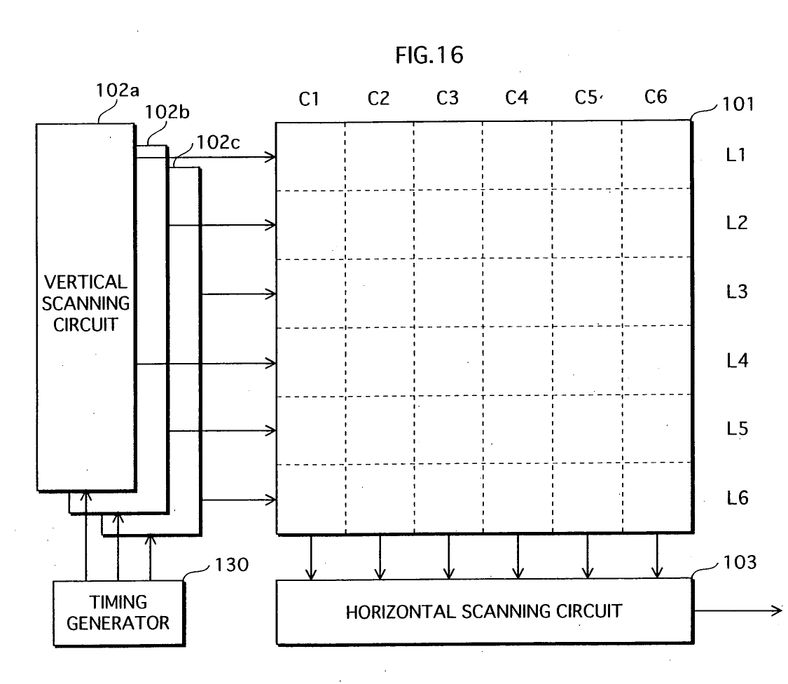

FIG. 16 shows a construction of a solid-state imaging device according to the seventh embodiment.

Only the imaging unit 101, vertical scanning circuits 102a, 102b, and 102c, the horizontal scanning circuit 103, and the timing generator 130 are shown in FIG. 16. The other construction elements are as shown in FIG. 5.

The photoelectric converters 2 are arranged two-dimensionally in the imaging unit 101. The photoelectric converters 2 are formed by covering the semiconductor substrate 1 with a mask having apertures of a same size, and introducing a dopant to the semiconductor substrate 1 by ion implantation.

The vertical scanning circuit 102a drives the photoelectric converters 2 belonging to lines L1 and L4. The vertical scanning circuit 102b drives the photoelectric converters 2 belonging to lines L2 and L5. The vertical scanning circuit 102c drives the photoelectric converters 2 belonging to lines L3 and L6. Each photoelectric converter 2 accumulates a charge in accordance with a driving pulse of a corresponding vertical scanning circuit, and outputs an electric signal based on the accumulated charge amount.

The horizontal scanning circuit 103 sequentially outputs electric signals output from the photoelectric converters 2, in units of columns.

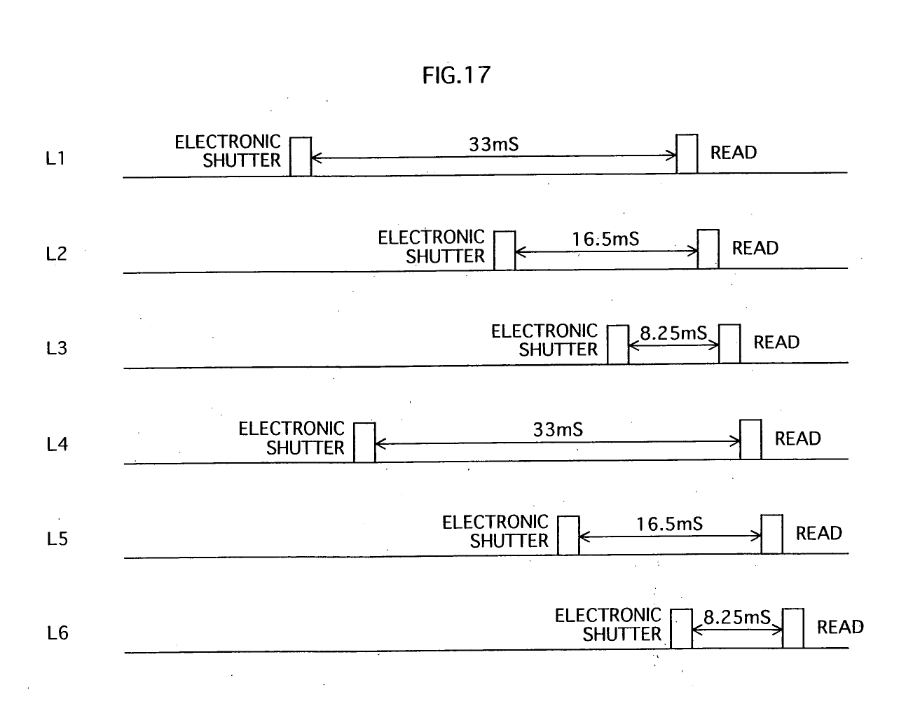

FIG. 17 is a timing chart showing the driving pulses of the vertical scanning circuits according to the seventh embodiment.

An electronic shutter pulse is a pulse for discharging an entire charge accumulated in a photoelectric converter 2. A read pulse is a pulse for outputting a charge accumulated in a photoelectric converter 2 as an electric signal.

Each of the vertical scanning circuits 102a, 102b, and 102c outputs a read pulse after outputting an electronic shutter pulse. A period from the output of the electric shutter pulse to the output of the read pulse is an exposure time. Exposure times determined by the vertical scanning circuits 102a, 102b, and 102c are respectively 33 mS, 16.5 mS, and 8.25 mS.

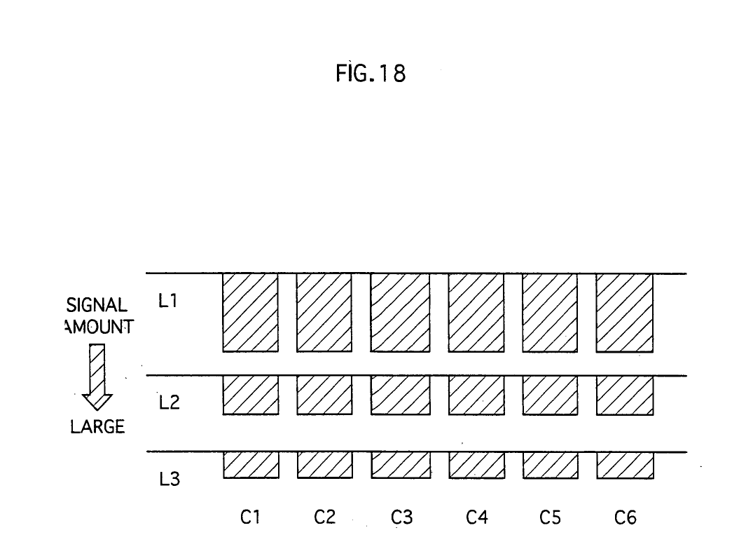

FIG. 18 shows a signal amount of each photoelectric converter according to the seventh embodiment.

Only lines L1, L2, and L3 are shown in FIG. 18. In the seventh embodiment, the vertical scanning circuits 102a, 102b, and 102c each have a different exposure time. This causes a different amount of signal to be generated in a photoelectric converter 2 depending on which line the photoelectric converter 2 belongs to. Since the exposure time decreases in the order of the vertical scanning circuits 102a, 102b, and 102c, the signal amount decreases in this order, too. By differing the exposure time in this way, the photoelectric converters having different sensitivities can be realized.

### Eighth Embodiment

An eighth embodiment of the present invention is a combination of the first and seventh embodiments.

The gray filters 6a, 6b, and 6c differ in visible light transmittance. In detail, the transmittances of the gray filters 6a, 6b, and 6c decrease in this order. The vertical scanning circuits 102a, 102b, and 102c differ in exposure time. In detail, the exposure times of the vertical scanning circuits 102a, 102b, and 102c decrease in this order. The apertures of the photo-shielding film 4 have a substantially same size.

The signal synthesis circuit 112 combines electric signals obtained from nine photoelectric converters belonging to three adjacent lines and three adjacent columns.

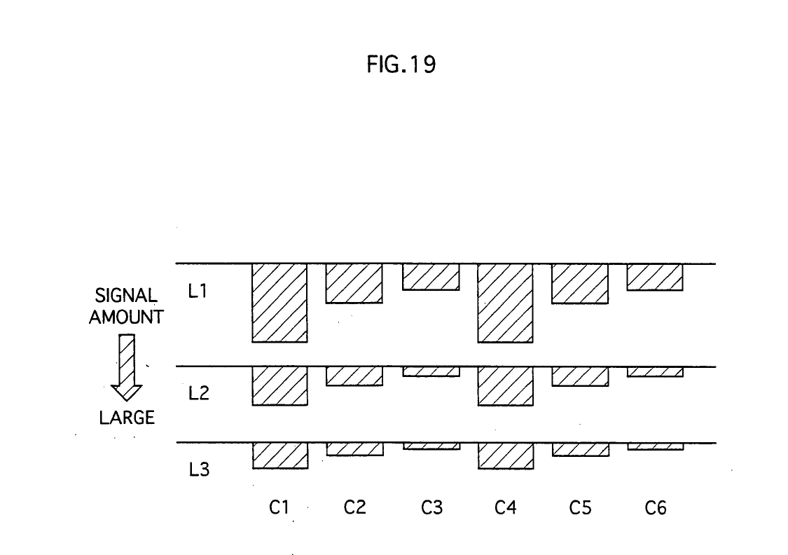

FIG. 19 shows a signal amount of each photoelectric converter according to the eighth embodiment.

Only lines L1, L2, and L3 are shown in FIG. 19. By combining the first embodiment (the adjustment of three sensitivities using gray filters) and the seventh embodiment (the adjustment of three sensitivities using exposure times) in this way, nine different sensitivities can be provided.

### Ninth Embodiment

A ninth embodiment of the present invention is a combination of the second and seventh embodiments.

The apertures 4a, 4b, and 4c of the photo-shielding film 4 differ in size. In detail, the sizes of the apertures 4a, 4b, and 4c decrease in this order. The vertical scanning circuits 102a, 102b, and 102c differ in exposure time. In detail, the exposures times of the vertical scanning circuits 102a, 102b, and 102c decrease in this order.

The signal synthesis circuit 112 combines electric signals obtained from nine photoelectric converters belonging to three adjacent lines and three adjacent columns.

By combining the second embodiment (the adjustment of three sensitivities using aperture sizes) and the seventh embodiment (the adjustment of three sensitivities using exposure times) in this way, nine different sensitivities can be provided.

### Tenth Embodiment

A tenth embodiment of the present invention is a combination of the fifth and seventh embodiments.

The gray filters 6a, 6b, and 6c differ in visible light transmittance. In detail, the transmittances of the gray filters 6a, 6b, and 6c decrease in this order. The vertical scanning circuits 102a, 102b, and 102c differ in exposure time. In detail, the exposure times of the vertical scanning circuits 102a, 102b, and 102c decrease in this order. The apertures of the photo-shielding film 4 have a substantially same size.

The signal synthesis circuit 112 combines electric signals obtained from nine photoelectric converters belonging to three adjacent lines and three adjacent columns.

The signal level judgment circuit 154 prohibits, if an electric signal output from the image sensor 100 is at the saturation level, the electric signal from being combined in the signal synthesis circuit 152.

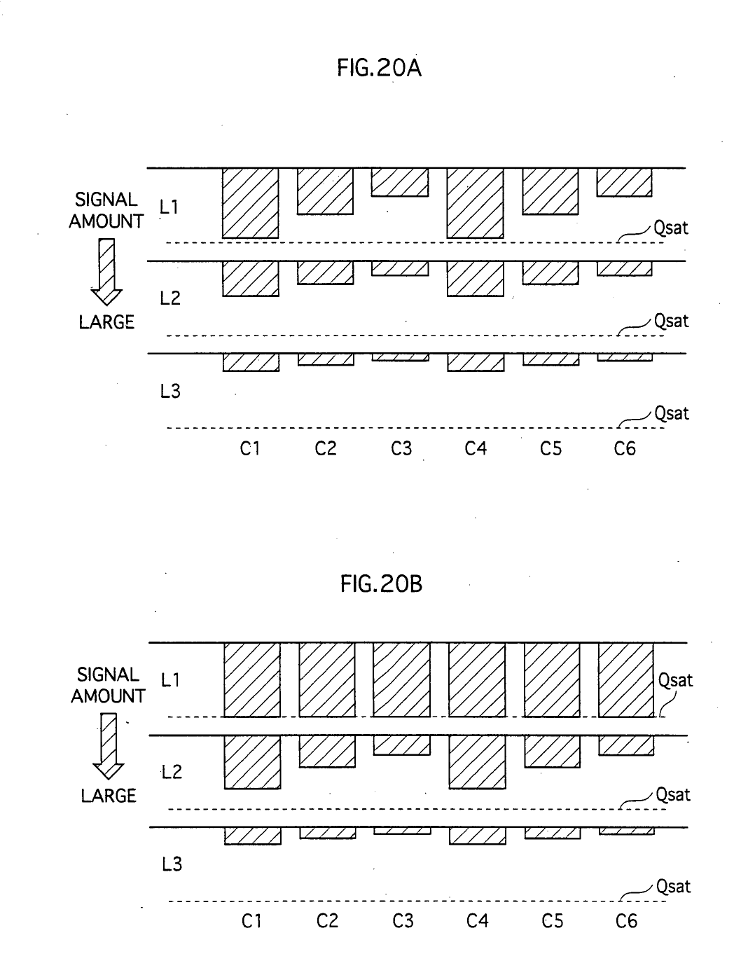

FIG. 20 shows a signal amount of each photoelectric converter according to the tenth embodiment.

Only lines L1, L2, and L3 are shown in FIG. 20. Qsat indicates the saturation level. In FIG. 20A, the electric signal obtained from each photoelectric converter is below the saturation level (low-brightness photographing mode). In this case, the nine electric signals obtained from the photoelectric converters belonging to the three adjacent lines and the three adjacent columns are all combined in the signal synthesis circuit 152. In FIG. 20B, on the other hand, due to a high light intensity, the electric signals obtained from the photoelectric converters belonging to line L1 have reached the saturation level (high-brightness photographing mode). In this case, the electric signals obtained from the photoelectric converters of line L1 are not combined in the signal synthesis circuit 152. Which is to say, only the unsaturated electric signals out of the nine electric signals obtained from the photoelectric converters belonging to the three adjacent lines and the three adjacent columns are combined in the signal synthesis circuit 152.

Thus, in the low-brightness photographing mode, the nine pixel signals are combined together, with it being possible to considerably widen the dynamic range. In the high-brightness photographing mode, meanwhile, only the unsaturated pixel signals out of the nine pixel signals are combined together, with it being possible to suppress a drop in resolution.

### Eleventh Embodiment

An eleventh embodiment of the present invention is a combination of the sixth and seventh embodiments.

The apertures 4a, 4b, and 4c of the photo-shielding film 4 differ in size. In detail, the sizes of the apertures 4a, 4b, and 4c decrease in this order. The vertical scanning circuits 102a, 102b, and 102c differ in exposure time. In detail, the exposure times of the vertical scanning circuits 102a, 102b, and 102c decrease in this order.

The signal level judgment circuit 154 prohibits, if an electric level output from the image sensor 100 is at the saturation level, the electric signal from being combined in the signal synthesis circuit 152.

By doing so, the same effects as the tenth embodiment can be achieved.

### Twelfth Embodiment

A twelfth embodiment of the present invention is different from the first embodiment in the construction of gray filters. The rest of the construction of the twelfth embodiment is the same as that of the first embodiment, and so its explanation has been omitted here.

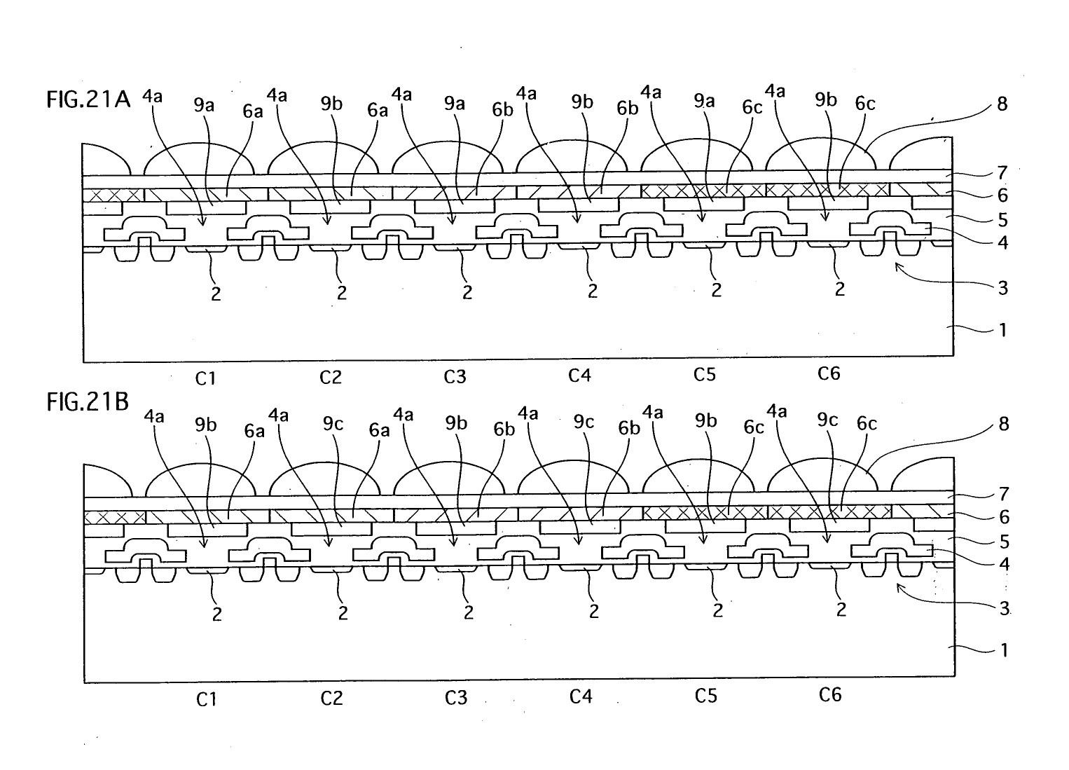

FIG. 21 is a sectional view of an image sensor according to the twelfth embodiment.

In this embodiment, liquid crystal filters are employed as the gray filters 6a, 6b, and 6c. A liquid crystal filter varies in visible light transmittance depending on an applied voltage. Accordingly, the sensitivity of a photoelectric converter can be changed by changing an applied voltage.

Although the solid-state imaging device according to the present invention has been described by way of the embodiments, the present invention should not be limited to the above. For example, the following modifications are possible.

(1) The above embodiments describe the case where the signal level judgment circuit and the signal synthesis circuit are included in the signal processing unit, but the present invention is not limited to this.

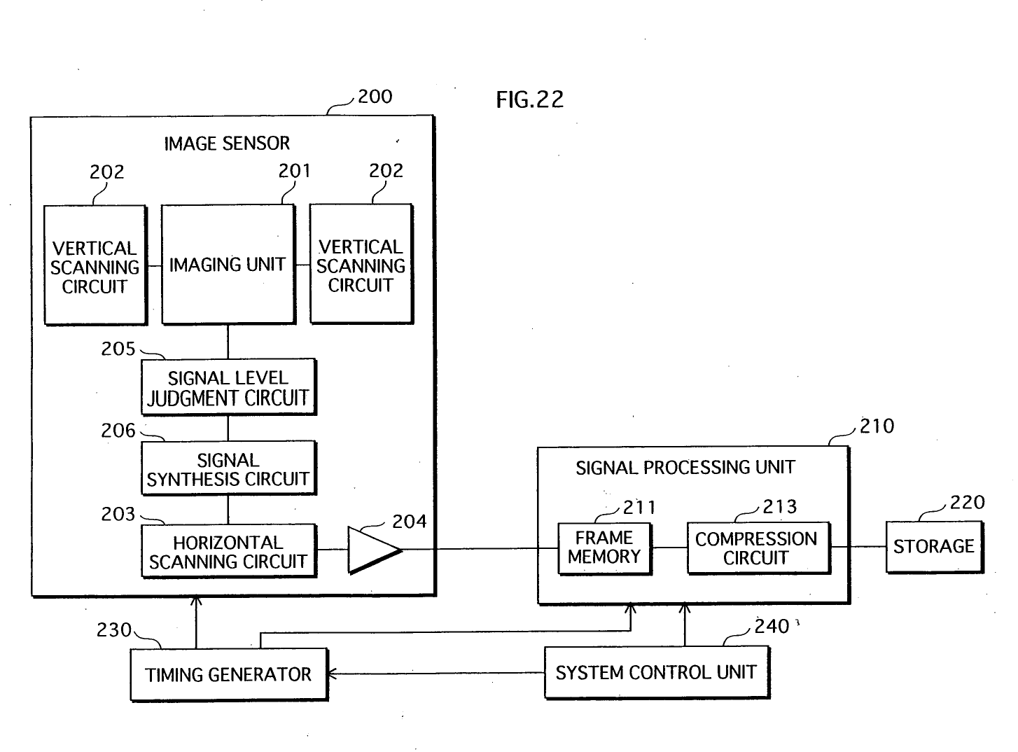

FIG. 22 shows a construction of a solid-state imaging device as a modification to the embodiments.

The solid-state imaging device includes an image sensor 200, a signal processing unit 210, a storage 220, a timing generator 230, and a system control unit 240.

The image sensor 200 includes an imaging unit 201, a vertical scanning circuit 202, a horizontal scanning circuit 203, an amplifier 204, a signal level judgment circuit 205, and a signal synthesis circuit 206.

The signal processing unit 210 includes a frame memory 211 and a compression circuit 213.

Thus, the signal level judgment circuit and the signal synthesis circuit may be included in the image sensor 200.

(2) The above embodiments describe the use of three levels or nine levels of sensitivity, but the present invention is not limited to such.

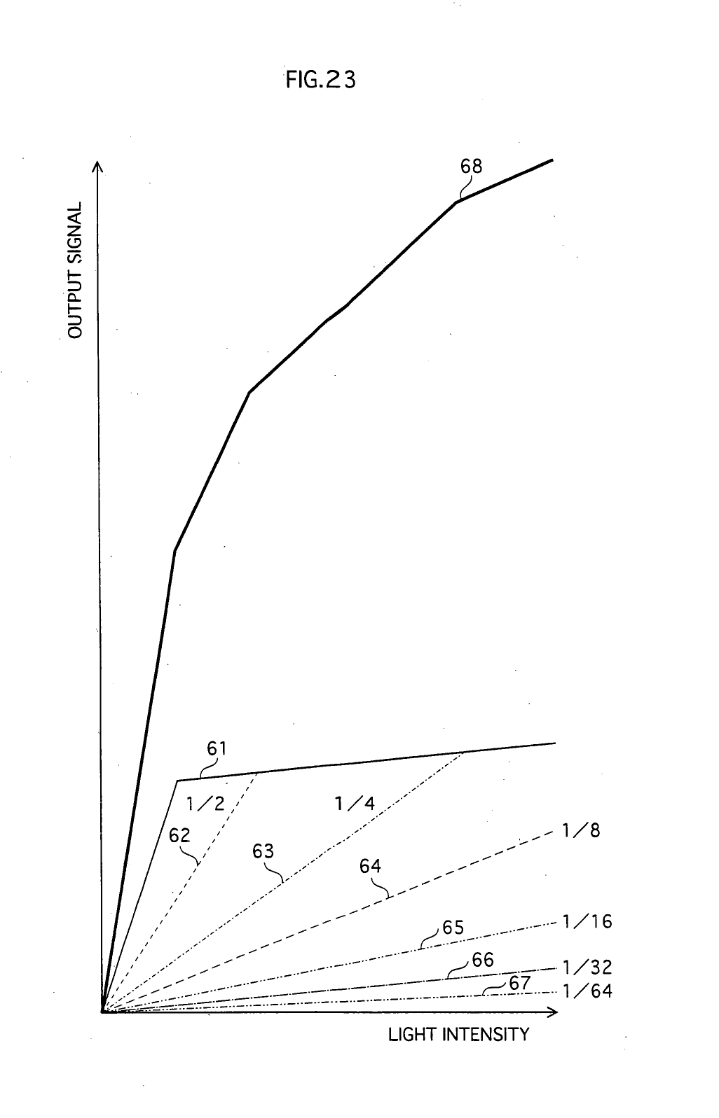

FIG. 23 shows output characteristics of a solid-state imaging device having seven different sensitivities.

Curves 61 to 67 each indicate output characteristics of a photoelectric converter 2 having a different rate of suppressing an amount of received light. A curve 68 indicates output characteristics when output signals of these photoelectric converters 2 are combined by signal processing. By such combining three or more electric signals, smooth output characteristics of a composite signal can be attained and the dynamic range can be greatly widened.

(3) The above embodiments describe the case where each photoelectric converter 2 has a substantially same capacity and a substantially same dopant concentration. However, this is not a limit for the present invention, which can equally be realized even when the photoelectric converters differ in capacity and dopant concentration.

Although the present invention has been fully described by way of examples with reference to the accompanying drawings, it is to be noted that various changes and modifications will be apparent to those skilled in the art.

Therefore, unless such changes and modifications depart from the scope of the present invention, they should be construed as being included therein.

What is claimed is:

1. A solid-state imaging device comprising:
a plurality of photoelectric converters each operable to generate and accumulate an amount of charge corresponding to an amount of received light;
a suppression unit operable to suppress the amount of received light of each of the plurality of photoelectric converters at a rate determined for the photoelectric converter; and
an obtaining unit operable to, for each group of a predetermined number of photoelectric converters, combine electric signals that are respectively based on amounts of charge accumulated in the predetermined number of photoelectric converters, thereby obtaining one composite signal for the predetermined number of photoelectric converters,
wherein a maximum amount of charge that is able to be accumulated is substantially same in each of the predetermined number of photoelectric converters, and the rate of suppression by the suppression unit is different in each of the predetermined number of photoelectric converters.

2. The solid-state imaging device of claim 1,
wherein the plurality of photoelectric converters are each provided on a substrate,
the suppression unit is an optical filter film that covers the substrate and transmits visible light, and
the rate of suppression by the suppression unit is different because a transmittance of visible light is different in each of areas of the optical filter film that correspond to the predetermined number of photoelectric converters.

3. The solid-state imaging device of claim 1,
wherein the plurality of photoelectric converters are each provided on a substrate,
the suppression unit is a photo-shielding film that covers the substrate and has apertures at positions corresponding to the plurality of photoelectric converters, and
the rate of suppression by the suppression unit is different because a size of an aperture corresponding to each of the predetermined number of photoelectric converters is different.

4. The solid-state imaging device of claim 1,
wherein the suppression unit includes:
a discharge unit operable to discharge a charge accumulated in each of the plurality of photoelectric converters; and
an accumulation unit operable to accumulate a charge in each of the plurality of photoelectric converters until a predetermined time period has elapsed since the discharge by the discharge unit, and
the rate of suppression by the suppression unit is different because a length of the predetermined time period is different for each of the predetermined number of photoelectric converters.

5. The solid-state imaging device of claim 1, further comprising:
a prohibition unit operable to, when an electric signal that is based on an amount of charge accumulated in any of the predetermined number of photoelectric converters indicates the maximum amount of charge, prohibit the obtaining unit from combining the electric signal.

6. The solid-state imaging device of claim 1,
wherein the plurality of photoelectric converters are formed by introducing a dopant to a semiconductor substrate, and
the maximum amount of charge is substantially same because each of the predetermined number of photoelectric converters has a substantially same capacity and a substantially same dopant concentration.

7. The solid-state imaging device of claim 1,
wherein the predetermined number is at least three.
